(19) United States
(12) Patent Application Publication
(10) Pub. No.: US 2018/0338817 A1
(43) Pub. Date: Nov. 29, 2018

(54) Retainer for Aligning Teeth and a Method for Creating Same

(71) Applicant: Khaled Eldin, Old Bridge, NJ (US)

(72) Inventor: Khaled Eldin, Old Bridge, NJ (US)

(21) Appl. No.: 16/055,419

(22) Filed: Aug. 6, 2018

(51) Int. Cl. A61C 7/08; A61C 7/00; A61C 9/00

(52) U.S. Cl. CPC A61C 7/08; A61C 9/0006; A61C 7/002

(57) ABSTRACT

According to an aspect of some embodiments of the teachings herein, there is provided a method of creating a retainer for aligning teeth of a specific user. The method includes creating a mold of the teeth of the specific user. Indentations are then placed into the mold, each indentation corresponding to a point at which pressure is to be applied to one of the teeth of the specific user. Using the mold including the indentations, forming a retainer, such that the retainer includes protrusions, each of the protrusions corresponding to one of the indentations. The resulting retainer matches the shape of the teeth of the specific user except for the protrusions, and when the retainer is worn by the specific user, each of the protrusions pushes on a specific tooth at a specific pressure point on the specific tooth, thereby causing the specific tooth to rotate, tilt, or move.

### FIELD OF THE DISCLOSED TECHNOLOGY

The disclosed technology relates generally to retainers for aligning teeth, and, more specifically, to a retainer formed by making an indentation in a mold of the teeth to create a protrusion in the retainer, which protrusion pushes against a desired tooth in a desired direction.

### BACKGROUND OF THE DISCLOSED TECHNOLOGY

Many people who have crooked or misaligned teeth, wish to have their teeth aligned, whether for medical reasons or for aesthetic reasons. However, to date, most alignment is by use of braces adhered or otherwise attached to the exterior of the teeth. Such braces are often very uncomfortable for the user, for example causing lacerations and wounds in the gums touching the braces. When the braces are placed on the outer surface of the teeth, they are visible and often look less aesthetic, and when they are placed on the inner surface of the teeth, they are often very uncomfortable.

Retainers, also known as bite plates, are also often used for straightening teeth. However, retainers are typically used either to retain the aligned position of the teeth reached by braces or other orthodontic tools, or to cause translation of the entire arc of teeth forward, backward, or sideways.

The prior art also describes various types of retainers, some of which are used to cause tilting or twisting of the teeth by placing a pressure point, or suitable protrusion, at a suitable location against the tooth.

U.S. Patent Publication 2016/0193014 to Morton et al. discloses an aligner with one or more activation forces to facilitate tooth movement. The activation forces are arranged to provide force in a direction opposite to an in-tended direction of tooth movement.

U.S. Patent Publication 2005/0186526 to Stewart et al. discloses adding a tissue remodeling substance between a retainer and the teeth. This adds a pressure point at various positions on the teeth, without the substance forming part of the mold of the retainer or of the actual retainer.

U.S. Pat. No. 8,439,672 to Matov et al. discloses a method for deter-mining a path of tooth movement and creating an aligner to cause same. The aligner is an attachment device which engages with the dental appliance (Abstract).

However, there remains a need in the art for a retainer which tilts or rotates the teeth by providing pressure points on the teeth, which pressure points are molded into, and form an integral part of, the retainer.

### SUMMARY OF THE DISCLOSED TECHNOLOGY

According to an aspect of some embodiments of the teachings herein, there is provided a method of creating a retainer for aligning teeth of a specific user. The method includes creating a mold of the teeth of the specific user. Indentations are then placed into the mold, each indentation corresponding to a point at which pressure is to be applied to one of the teeth of the specific user. Using the mold including the indentations, forming a retainer, such that the retainer includes protrusions, each of the protrusions corresponding to one of the indentations. The resulting retainer matches the shape of the teeth of the specific user except for the protrusions, and when the retainer is worn by the specific user, each of the protrusions pushes on a specific tooth of the teeth at a specific pressure point on the specific tooth, thereby causing the specific tooth to rotate, tilt, or move.

In some embodiments, at least one indentation is formed in a front surface of one of the teeth in the mold.

In some embodiments, the indentation is placed in an upper portion of the front surface. A corresponding protrusion in the retainer is adapted to push on an upper portion of a front surface of the corresponding tooth, thereby to tilt the corresponding tooth outward.

In some embodiments, the indentation is placed in a bottom portion of the front surface. A corresponding protrusion in the retainer is adapted to push on a bottom portion of a front surface of the corresponding tooth, thereby to tilt the corresponding tooth inward.

In some embodiments, at least one indentation is formed in a back surface of one of the teeth in the mold.

In some embodiments, the indentation is placed in an upper portion of the back surface. A corresponding protrusion in the retainer is adapted to push on an upper portion of a back surface of the corresponding tooth, thereby to tilt the corresponding tooth inward.

In some embodiments, the indentation is placed in a bottom portion of the back surface. A corresponding protrusion in the retainer is adapted to push on a bottom portion of the back surface of the corresponding tooth, thereby to tilt the corresponding tooth outward.

In some embodiments, at least one indentation is formed in at least one of a right-side portion or a left side portion of one of the teeth in the mold.

In some embodiments, the multiple indentation are placed on the right side portion of one of the teeth, on the same surface thereof. Corresponding protrusions in the retainer are adapted to push on a right side portion of the corresponding tooth thereby to move the corresponding tooth to the left.

In some embodiments, multiple indentations are placed on the left side portion of one of the teeth, on the same surface thereof. Corresponding protrusions in the retainer are adapted to push on a left side portion of the corresponding tooth thereby to move the corresponding tooth to the right.

In some embodiments, a first indentation is placed on the right side portion of a first surface of one of the teeth, and a second indentation is placed on the left side portion of the opposing surface of the same tooth. Corresponding protrusions in the retainer are adapted to push on a right side portion of one surface of the corresponding tooth and on a left side portion of the opposing surface of the corresponding tooth, thereby to rotate the corresponding tooth.

There is further provided in accordance with another aspect of the disclosed technology a method for aligning the teeth of a specific user, the method including creating a retainer for aligning the teeth of the specific user using the method of the disclosed technology, and placing the retainer on teeth of the specific user, such that the protrusions apply pressure onto the points in the teeth of the specific user. The retainer is maintained on the teeth for a predetermined duration, until pressure applied by the protrusions results in aligning of the teeth.

There is additionally provided in accordance with another aspect of the disclosed technology a mold for creating a retainer for aligning teeth of a specific user, the mold including a model of the teeth of the specific user, and a plurality of indentations formed in surfaces of teeth of the model. Each indentation corresponds to a point at which pressure is to be applied to one of the teeth of the specific user. A retainer formed using the mold is adapted to apply pressure to the teeth of the specific user at the points, thereby to move, tilt, or rotate a tooth to which pressure is applied.

There is further provided in accordance with another aspect of the disclosed technology, a retainer for aligning teeth of a specific user, formed using the mold of the disclosed technology, the retainer including a trough having a shape corresponding in shape to a shape of the teeth of the specific user and adapted to be mounted thereon. The retainer includes a plurality of protrusions corresponding to the indentations in the model, such that when the specific user wears the retainer, the plurality of protrusions apply pressure at the pressure points, thereby to move, tile, or rotate, a tooth to which pressure is applied.

In some embodiments, a protrusion is formed in a surface of the trough engaging a front surface of one of the teeth of the user, thereby to tilt the tooth or to move the tooth backwards.

In some embodiments, a protrusion is formed in a surface of the trough engaging a back surface of one of the teeth of the user, thereby to tilt the tooth or to move the tooth forwards.

In some embodiments, a protrusion is formed in a surface of the trough engaging a right side portion of one of the surfaces of one of the teeth of the user, thereby to move the tooth to the left.

In some embodiments, a protrusion is formed in a surface of the trough engaging a left side portion of one of the surfaces of one of the teeth of the user, thereby to move the tooth to the right.

In some embodiments, one of the protrusions is formed in a first surface of the trough engaging one side portion of one of the surfaces of one tooth of the specific user, and a second of the protrusions is formed in a second surface of the trough engaging an opposing side portion of an opposing surface of the one tooth of the specific user, thereby to rotate the tooth.

In same embodiments, multiple retainers with differently placed protrusions are used for a same user or wearer thereof. After the teeth have been moved, at least somewhat, due to the protrusions of a first retainer, a second retainer is used with protrusions placed in the same but deeper or in different positions. Used serially, the retainers in combination rotate/move the teeth or a tooth more subsequently over time.

“Substantially” and “substantially shown,” for purposes of this specification, are defined as “at least 90%,” or as otherwise indicated. “Identical” or “exactly,” for purposes of this specification, is defined as “within an acceptable tolerance level known in the art.” Any device may “comprise,” or “consist of,” the devices mentioned there-in, as limited by the claims. Any element described may be one of “exactly” or “substantially,” as described.

It should be understood that the use of “and/or” is defined inclusively, such that the term “a and/or b” should be read to include the sets: “a and b,” “a or b,” “a,” or “b.”

### BRIEF DESCRIPTION OF THE DRAWINGS

FIG. 1 is a perspective view illustration of a retainer mold including a model of a user's teeth, having a retainer molded thereon according to an embodiment of the disclosed technology.

FIG. 2 is a perspective view illustration of a retainer mold including a plurality of indentations according to an embodiment of the disclosed technology.

FIG. 3 is a perspective view illustration of a retainer formed on the retainer mold of FIG. 2, the retainer including a plurality of protrusions, according to an embodiment of the disclosed technology.

FIGS. 4A and 4B are plan view illustrations of indentations formed in a retainer mold for moving a tooth forward or backward, or for tilting of the tooth forward or backward, FIG. 4A showing indentations formed in the front of the mold and FIG. 4B showing indentations formed in the back of the mold.

FIGS. 5A and 5B are plan view illustrations of indentations formed in a retainer mold for rotating a tooth to the left, FIG. 5A showing indentation formed in the front left side of the tooth mold and FIG. 5B showing a corresponding indentation formed in the back right side of the tooth mold.

FIGS. 6A and 6B are plan view illustrations of indentations formed in a retainer mold for rotating a tooth to the right, FIG. 6A showing indentation formed in the front right side of the tooth mold and FIG. 6B showing a corresponding indentation formed in the back left side of the tooth mold.

FIGS. 7A and 7B are plan view illustrations of indentations formed in a retainer mold for tilting a tooth forward or backward, FIG. 7A showing indentations formed in the front of the mold for tilting the tooth backward and FIG. 7B showing indentations formed in the back of the mold for tilting the tooth forward.

FIGS. 8A and 8B are plan view illustrations of indentations formed in a retainer mold for moving a tooth sideways, FIG. 8A showing indentations formed in the front of the mold for moving the tooth to the right and FIG. 8B showing indentations formed in the back of the mold for moving the tooth to the left.

### DETAILED DESCRIPTION OF EMBODIMENTS OF THE DISCLOSED TECHNOLOGY

In an embodiment of the disclosed technology, a retainer is molded with one or more protrusions on surfaces which engage surfaces of the teeth. The protrusions in the retainer are formed by creating corresponding indentations in the mold used for creating the retainer. The locations of the protrusions are specifically selected to push the teeth engaged by the protrusions in a desired direction, so as to align the teeth. As described in detail hereinbelow, the protrusions may be placed to move a tooth forward or backward, to the right or to the left, to tilt the edge of the tooth forward or backward, or to rotate the tooth to the right or to the left.

According to an aspect of some embodiments of the teachings herein, there is provided a method of creating a retainer for aligning teeth of a specific user. The method includes creating a mold of the teeth of the specific user. Indentations are then placed into the mold, each indentation corresponding to a point at which pressure is to be applied to one of the teeth of the specific user. Using the mold including the indentations, forming a retainer, such that the retainer includes protrusions, each of the protrusions corresponding to one of the indentations. The resulting retainer matches the shape of the teeth of the specific user except for the protrusions, and when the retainer is worn by the specific user, each of the protrusions pushes on a specific tooth of the teeth at a specific pressure point on the specific tooth, thereby causing the specific tooth to rotate, tilt, or move.

Embodiments of the disclosed technology will become clearer in view of the following description of the drawings.

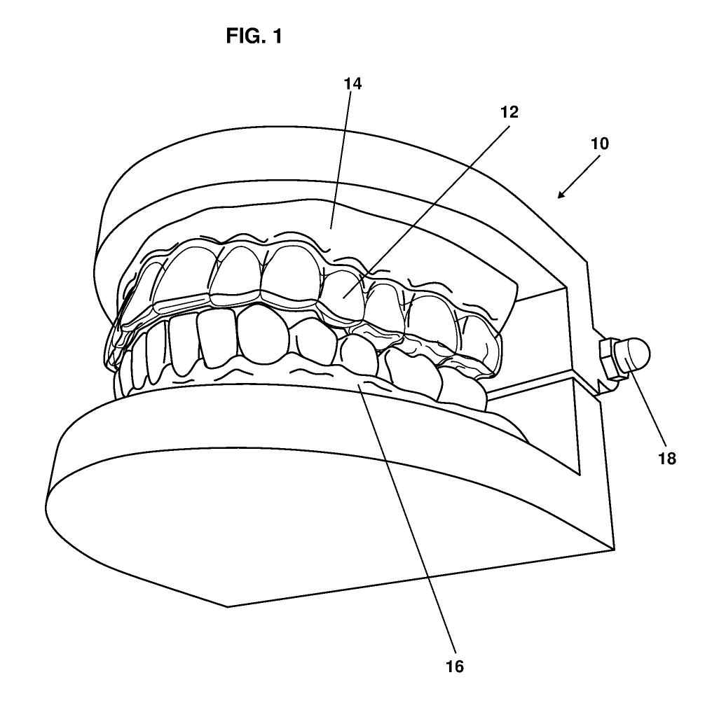

FIG. 1 is a perspective view illustration of a retainer mold 10 including a model of a user's teeth, having a retainer 12 molded thereon according to an embodiment of the disclosed technology. As seen in FIG. 1, the mold 10 includes an upper portion 14 which models the user's upper gums and teeth, and a lower portion 16 which models the user's lower gums and teeth. The upper and lower portions may be connected, for example using a screw or hinge 18.

Retainer 12 is illustrated on the upper portion 14 of the model, engaging the modeled upper teeth. The illustrated retainer is transparent.

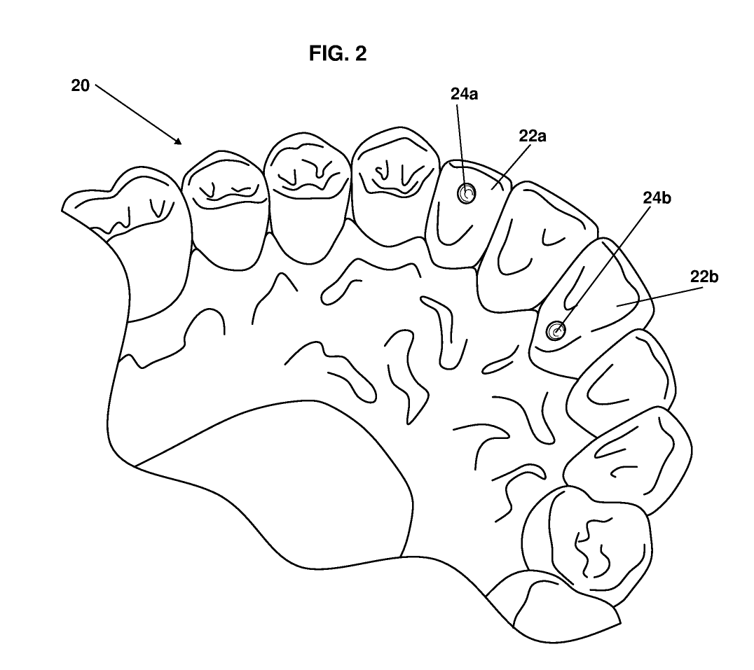

Reference is now made to FIG. 2, which is a perspective view illustration of a retainer mold 20 of lower teeth of a user, including a plurality of indentations according to an embodiment of the disclosed technology. The indentations are made in the mold of the teeth, the indentations corresponding to points at which pressure should be applied to the teeth.

In the illustrated embodiment, a first indentation 22a is made at an upper third of the back surface of a first modeled tooth 24a, and a second indentation 22b is made at the lower third of the back surface of a second modeled tooth 24b.

FIG. 3 is a perspective view illustration of a retainer 30 formed on the retainer mold 20 of FIG. 2. The retainer 30 includes a first protrusion 32a corresponding to indentation 22a in mold 20, and a second protrusions 32b corresponding to indentation 22b in mold 20.

In the retainer 30 of FIG. 3, the protrusions 32a and 32b are located along an inner surface of the retainer, and adapted to push the back surfaces of teeth corresponding to modeled teeth 24a and 24b. However, it is appreciated that the protrusions may be arranged to push against any surface of the tooth, depending on the corresponding location of the indentation in the retainer mold. The locations of the protrusions may be selected by an orthodontist or other dental practitioner so as to apply pressure at suitable pressure points on the teeth, depending on the changes to the teeth required for alignment thereof.

As explained in further detail hereinbelow, retainers according to the disclosed technology may be used for translation of a tooth location, rotation of a tooth right or left, or tipping of a tooth inwards or outwards, depending on the specific locations at which the protrusions in the retainer apply pressure to the teeth.

In the present specification and claims, the terms “translation of a tooth” and “moving of a tooth” are used interchangeably, and relate to moving of a tooth from a first location to a second location, different from the first location, while maintaining the three dimensional orientation of the tooth. In other words, translation of a tooth that is tipped outwards, toward the lip, would maintain the tooth tipped outwards, and would move the whole tooth forward (toward the lips), backward (towards the interior of the mouth) or sideways.

In the present specification and claims, the term “rotation of a tooth” relates to rotation of the tooth sideways, about a longitudinal axis of the tooth.

In the present specification and claims, the terms “tipping of a tooth”, “tilting of a tooth”, and “twisting the tooth forward/backward” are used interchangeably and relate to changing the angular orientation of the tooth about an axis parallel to the tip of the tooth.

In the present specification and claims, moving a tooth or a portion thereof forward relates to moving the tooth, or the portion of the tooth, towards the exterior of the mouth, or towards the lips. Inversely, moving a tooth or a portion of the tooth backward relates to moving the tooth, or the portion thereof, towards the interior of the mouth, or towards the tongue.

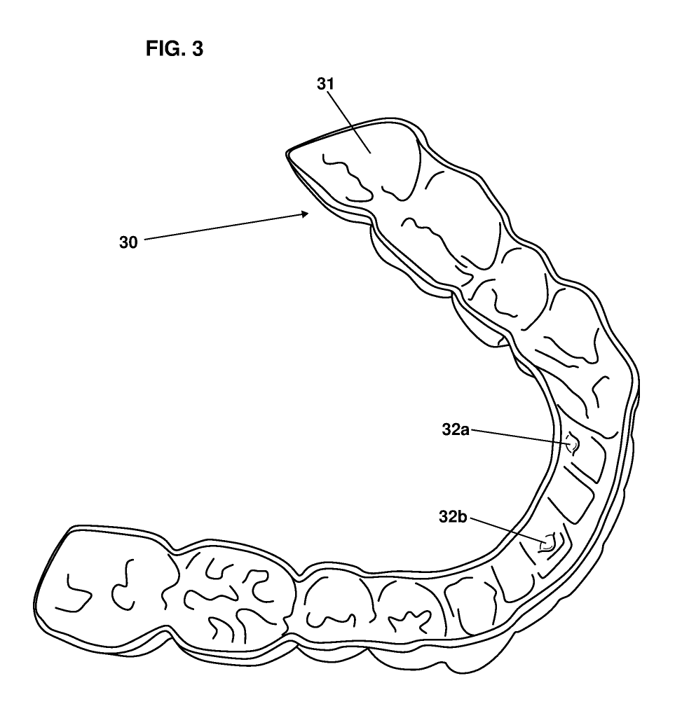

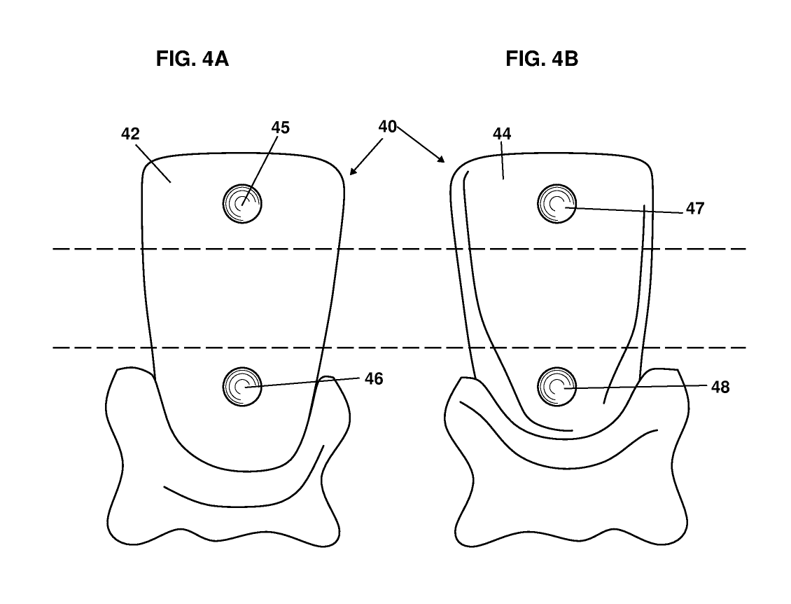

In the present specification and claims, the directions “left” and “right” relate to the orientation of a tooth in the user's mouth, and to a direction of movement of the tooth relative to the user's right and left sides, not to the arrangement of the drawing on paper or to the direction of movement of the tooth relative to a person looking at the user. In the illustrated embodiments of FIGS. 4A to 8B, the illustrated tooth is a lower incisor, and as such the directions “left” and “right” correspond to the directions on the paper of the back surface of the tooth.

FIGS. 4A and 4B are plan view illustrations of indentations formed in a retainer mold for moving a tooth forward or backward, or for tilting of the tooth forward or backward. FIG. 4A shows indentations formed in a front surface 42 of a tooth 40 in the mold, and FIG. 4B shows indentations formed in back surface 44 of the tooth 40 in the mold.

Specifically, FIG. 4A shows a first indentation 45 at the center of an upper third of the front surface 42 of tooth 40, and a second indentation 46 at the center of a lower third of the front surface 42 of tooth 40. Similarly, FIG. 4B shows a first indentation 47 at the center of an upper third of the back surface 44 of tooth 40, and a second indentation 48 at the center of a lower third of the back surface 44 of tooth 40.

It will be appreciated that for different types of alignment corrections of a tooth corresponding to the tooth 40 in the mold, different ones of the indentations may be used.

For example, for translation of the tooth corresponding to tooth 40 of the mold forward, pressure would need to be applied by the retainer at the rear surface of the tooth, equally at upper and lower portions thereof. As such, for this purpose, the user would maintain indentations 47 and 48 in back surface 44 of the mold tooth, resulting in protrusions in the retainer which would apply pressure to the back surface of the tooth. In this case, the indentations 45 and 46 on front surface 42 of the tooth 40 in the mold would be obviated, so as to prevent pressure from being applied by the retainer to the front of the tooth, which would negate the pressure applied by the protrusions in the retainer to the back surface of the tooth for moving the tooth forward.

Conversely, for translation of the tooth corresponding to tooth 40 of the mold backward, pressure would need to be applied by the retainer at the front surface of the tooth, equally at upper and lower portions thereof. As such, for this purpose, the user would maintain indentations 45 and 46 in front surface 42 of the mold tooth, resulting in protrusions in the retainer which would apply pressure to the front surface of the tooth. In this case, the indentations 47 and 48 on back surface 44 of the tooth 40 in the mold would be obviated, so as to prevent pressure from being applied by the retainer to the back of the tooth, which would negate the pressure applied by the protrusions in the retainer to the front surface of the tooth for moving the tooth backward.

As another example, to twist or tilt the tooth corresponding to tooth 40 of the mold forward, the top of the tooth would need to be pushed forward, while pushing the bottom of the tooth backward. As such, pressure would need to be applied by the retainer at the upper portion of the rear surface of the tooth and at the lower portion of the front surface of the tooth. For this purpose, the user would maintain indentation 47 in back surface 44 of the mold tooth, as well as indentation 46 in front surface 42 of the mold tooth, resulting in protrusions in the retainer which would apply pressure to the upper back surface of the tooth and to the lower front surface of the tooth. In this case, indentation 45 on front surface 42 and indentation 48 on back surface 44 of the tooth 40 in the mold would be obviated, so as to prevent pressure from being applied by the retainer in directions opposing the desired directions of pressure.

Conversely, to twist or tilt the tooth corresponding to tooth 40 of the mold backward, the top of the tooth would need to be pushed backward, while pushing the bottom of the tooth forward. As such, pressure would need to be applied by the retainer at the upper portion of the front surface of the tooth and at the lower portion of the back surface of the tooth. For this purpose, the user would maintain indentation 45 in front surface 42 of the mold tooth, as well as indentation 48 in back surface 44 of the mold tooth, resulting in protrusions in the retainer which would apply pressure to the upper front surface of the tooth and to the lower back surface of the tooth. In this case, indentation 46 on front surface 42 and indentation 47 on back surface 44 of the tooth 40 in the mold would be obviated, so as to prevent pressure from being applied by the retainer in directions opposing the desired directions of pressure.

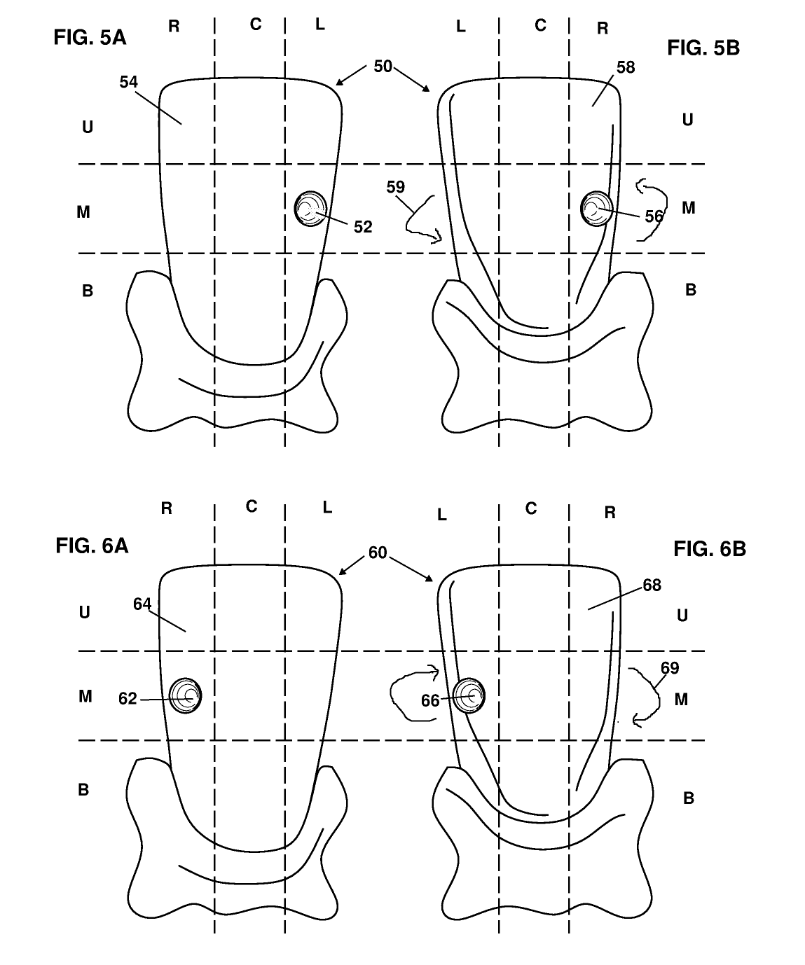

Reference is now made to FIGS. 5A and 5B, which are plan view illustrations of indentations formed in tooth 50 of a retainer mold, for rotating a corresponding tooth in the user's mouth to the left, and to FIGS. 6A and 6B, which are plan view illustrations of indentations formed in tooth 60 of a retainer mold, for rotating a corresponding tooth in the user's mouth to the right.

FIGS. 5A to 5B show the tooth 50 divided into nine sectors, to illustrate the desired location of the indentations. FIGS. 6A and 6B show the tooth 60 with similar sectoring, for the same purpose. The sectoring includes upper (U), middle (M), and bottom (B) rows, and right (R), center (C), and left (L) columns. As such, each sector of the nine sectors is indicated by a pair of letters, the first indicating the row of the sector and the other indicating the column of the sector. The sectors are determined according to the arrangement of the tooth in the user's mouth and relative to the user's right and left sides, and are indicated in the drawings for clarity and convenience of understanding.

FIG. 5A shows an indentation 52 formed in the middle left (ML) sector of a front surface 54 of the tooth 50 in the mold. FIG. 5B show a corresponding indentation 56 formed in the middle right (MR) sector of a back surface 58 of tooth 50 in the mold. A retainer formed using the mold of tooth 50, would include a protrusion applying pressure to the middle left (ML) sector of the front surface of the tooth corresponding to tooth 50 of the mold, and another protrusion applying pressure to the middle right (MR) sector of the back surface of the tooth corresponding to tooth 50 of the mold. As such, because of pressure from opposing sides and in the same direction, the tooth would be rotated to the left, in a direction indicated by arrows 59 in FIG. 5B.

FIG. 6A shows an indentation 62 formed in the middle right (MR) sector of a front surface 64 of the tooth 60 in the mold. FIG. 6B show a corresponding indentation 66 formed in the middle left (ML) sector of a back surface 68 of tooth 60 in the mold. A retainer formed using the mold of tooth 60, would include a protrusion applying pressure to the middle right (MR) sector of the front surface of the tooth corresponding to tooth 60 of the mold, and another protrusion applying pressure to the middle left (ML) sector of the back surface of the tooth corresponding to tooth 60 of the mold. As such, because of pressure from opposing sides and in the same direction, the tooth would be rotated to the right, in a direction indicated by arrows 69 in FIG. 6B.

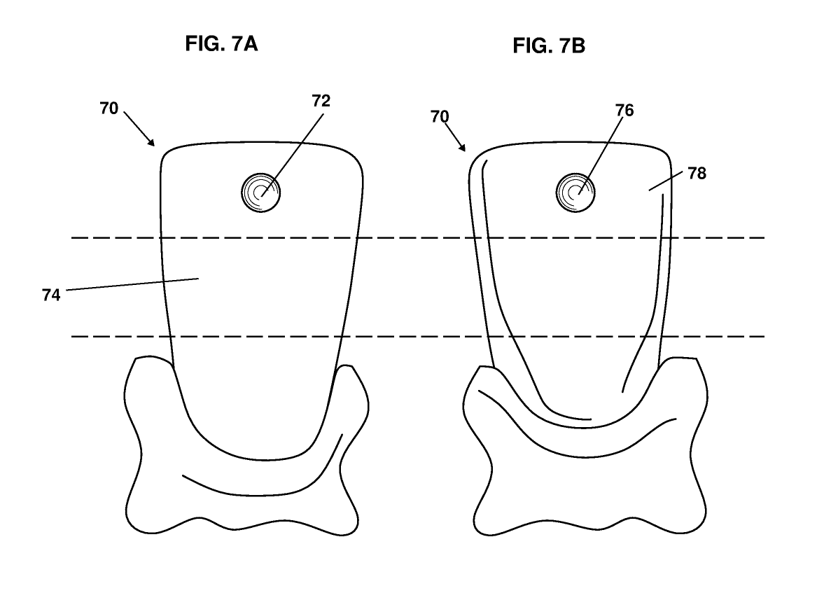

FIGS. 7A and 7B are plan view illustrations of indentations formed in a retainer mold for tilting a tooth 70 forward or backward. FIG. 7A shows an indentation 72 formed in the center of an upper third of a front surface 74 of tooth 70 in the mold, and FIG. 4B shows an indentation 76 formed in the center of an upper third of a back surface 78 of the tooth 70 in the mold.

To tilt the tooth corresponding to tooth 70 of the mold forward, the top of the tooth would need to be pushed forward. As such, pressure would need to be applied by the retainer at the upper portion of the rear surface of the tooth. For this purpose, the user would maintain indentation 76 in back surface 78 of the mold tooth, and would obviate indentation 72 on front surface 74 of the tooth 70 in the mold.

Conversely, to tilt the tooth corresponding to tooth 70 of the mold backward, the top of the tooth would need to be pushed backward. As such, pressure would need to be applied by the retainer at the upper portion of the front surface of the tooth. For this purpose, the user would maintain indentation 72 on front surface 74 of the mold tooth, and would obviate indentation 76 in back surface 78 of the tooth 70 in the mold.

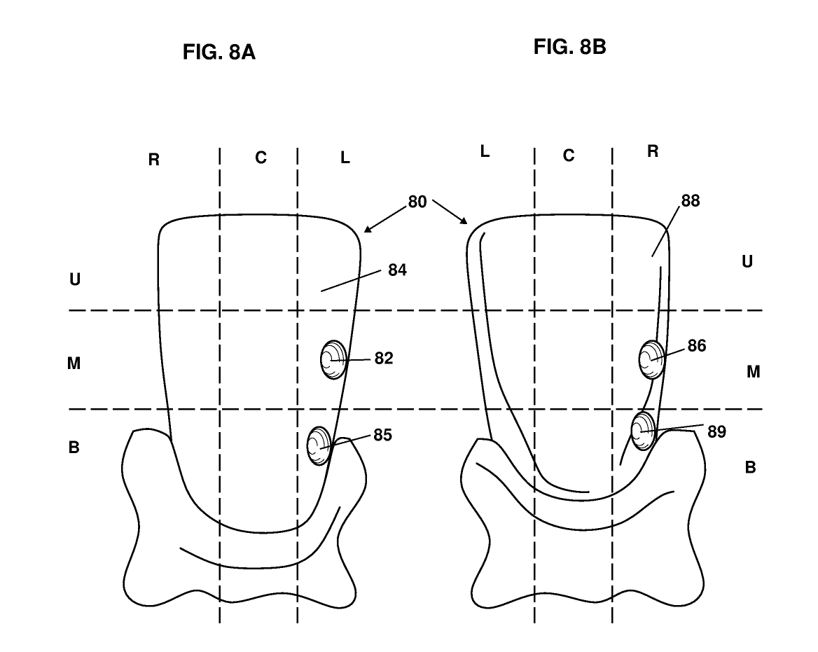

Reference is now made to FIGS. 8A and 8B, which are plan view illustrations of indentations formed in a retainer mold for moving a tooth 80 sideways.

FIGS. 8A and 8B show the tooth 80 divided into nine sectors, to illustrate the desired location of the indentations, similarly to the sectoring of tooth 50 of FIGS. 5A and 5B, and of tooth 60 of FIGS. 6A and 6B.

FIG. 5A shows a first indentation 82 formed in the middle left (ML) sector of a front surface 84 of the tooth 80 in the mold, and a second indentation 85 formed in the bottom left (BL) sector of the front surface 84. A retainer formed using the indentations 82 and 85 of FIG. 8A, would include protrusions applying pressure to the middle left (ML) and bottom left (BL) sectors of the front surface of the tooth corresponding to tooth 80 of the mold. As such, the tooth would be pushed to the right, in a direction away from the protrusions.

FIG. 8B show a first indentation 86 formed in the middle right (MR) sector of a back surface 88 of tooth 80 in the mold, and a second indentation 89 formed in the bottom right (BR) sector of the back surface 88. A retainer formed using the indentations 86 and 89 of FIG. 8B, would include protrusions applying pressure to the middle right (ML) and bottom right (BL) sectors of the back surface of the tooth corresponding to tooth 80 of the mold. As such, the tooth would be pushed to the left, in a direction away from the protrusions.

It will be appreciated that though the illustrated embodiments each show a single type of motion (translation, rotation, or tilting) on a single tooth, suitable indentations may be formed in a mold so as to move a single tooth in multiple direction, as required for alignment of the tooth. For example, a single tooth may be tilted backwards and rotated to the right, by appropriate placement of protrusion on the retainer, and of corresponding indentations on the mold. Similarly, it will be appreciated that a single retainer may include multiple protrusions for simultaneously affecting multiple teeth as required, and that the corresponding mold would include multiple corresponding indentations in the mold of multiple of the user's teeth.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope.

Combinations of any of the methods and apparatuses described hereinabove are also contemplated and within the scope of the invention.

1. A method of creating a retainer for aligning teeth of a specific user, the method comprising:
creating a mold of the teeth of the specific user;
placing indentations into said mold, each indentation corresponding to a point at which pressure is to be applied to one of the teeth of the specific user; and
using said mold including said indentations, forming a retainer, such that said retainer includes protrusions, each of said protrusions corresponding to one of said indentations,
wherein said retainer matches the shape of the teeth of the specific user except for said protrusions, and wherein when said retainer is worn by the specific user, each of said protrusions pushes on a specific tooth of the teeth at a specific pressure point on said specific tooth, thereby causing said specific tooth to, at least one of, rotate, tilt, or move.

2. The method of claim 1, wherein said placing indentations comprises placing at least one indentation in a front surface of one of the teeth in said mold.

3. The method of claim 2, wherein said placing at least one indentation comprises placing said at least one indentation in an upper portion of said front surface, such that a corresponding said protrusion in said retainer is adapted to push on an upper portion of an front surface of the corresponding tooth thereby to tilt the corresponding tooth outward.

4. The method of claim 2, wherein said placing at least one indentation comprises placing said at least one indentation in a bottom portion of said front surface, such that a corresponding said protrusion in said retainer is adapted to push on a bottom portion of a front surface of the corresponding tooth thereby to tilt the corresponding tooth inward.

5. The method of claim 1, wherein said placing indentations comprises placing at least one indentation in a back surface of one of the teeth in said mold.

6. The method of claim 5, wherein said placing at least one indentation comprises placing said at least one indentation in an upper portion of said back surface, such that a corresponding said protrusion in said retainer is adapted to push on an upper portion of a back surface of the corresponding tooth thereby to tilt the corresponding tooth inward.

7. The method of claim 5, wherein said placing at least one indentation comprises placing said at least one indentation in a bottom portion of said back surface, such that a corresponding said protrusion in said retainer is adapted to push on a bottom portion of the back surface of the corresponding tooth thereby to tilt the corresponding tooth outward.

8. The method of claim 1, wherein said placing indentations comprises placing at least one indentation in at least one of a right-side portion or a left side portion of one of the teeth in said mold.

9. The method of claim 8, wherein said placing at least one indentation comprises placing multiple indentations on the right side portion of said one of the teeth, on the same surface thereof, such that corresponding protrusions in said retainer are adapted to push on a right side portion of the corresponding tooth thereby to move the corresponding tooth to the left.

10. The method of claim 8, wherein said placing at least one indentation comprises placing multiple indentations on the left side portion of said one of the teeth, on the same surface thereof, such that corresponding protrusions in said retainer are adapted to push on a left side portion of the corresponding tooth thereby to move the corresponding tooth to the right.

11. The method of claim 8, wherein said placing at least one indentation comprises placing a first indentation on the right side portion of a first surface of said one of the teeth, and a second indentation on the left side portion of the opposing surface of said one of said teeth, such that corresponding protrusions in said retainer are adapted to push on a right side portion of one surface of the corresponding tooth and on a left side portion of the opposing surface of the corresponding tooth, thereby to rotate the corresponding tooth.

12. A method for aligning the teeth of a specific user, the method comprising:
creating a retainer for aligning the teeth of the specific user using the method of claim 1;
placing said retainer on teeth of the specific user, such that said protrusions apply pressure onto said points in the teeth of the specific user; and
maintaining said retainer on the teeth for a predetermined duration, until pressure applied by said protrusions results in aligning of the teeth.

13. A mold for creating a retainer for aligning teeth of a specific user, the mold including a model of the teeth of the specific user, and a plurality of indentations formed in surfaces of teeth of said model, each indentation corresponding to a point at which pressure is to be applied to one of the teeth of the specific user,
wherein a retainer formed using said mold is adapted to apply pressure to the teeth of the specific user at said points, thereby to move, tilt, or rotate a tooth to which pressure is applied.

14. A retainer for aligning teeth of a specific user, formed using the mold of claim 13, said retainer including a trough having a shape corresponding in shape to a shape of the teeth of the specific user and adapted to be mounted thereon, and a plurality of protrusions corresponding to said indentations, such that when the specific user wears said retainer, said plurality of protrusions apply pressure at said points, thereby to move, tile, or rotate, a tooth to which pressure is applied.

15. The retainer of claim 14, wherein at least one of said protrusions is formed in a surface of said trough engaging a front surface of one of the teeth of the user, thereby to tilt the tooth or to move the tooth backwards.

16. The retainer of claim 14, wherein at least one of said protrusions is formed in a surface of said trough engaging a back surface of one of the teeth of the user, thereby to tilt the tooth or to move the tooth forwards.

17. The retainer of claim 14, wherein at least one of said protrusions is formed in a surface of said trough engaging a right side portion of one of the surfaces of one of the teeth of the user, thereby to move the tooth to the left.

18. The retainer of claim 14, wherein at least one of said protrusions is formed in a surface of said trough engaging a left side portion of one of the surfaces of one of the teeth of the user, thereby to move the tooth to the right.

19. The retainer of claim 14, wherein one of said protrusions is formed in a first surface of said trough engaging one side portion of one of the surfaces of one tooth of the specific user, and a second of said protrusions is formed in a second surface of said trough engaging an opposing side portion of an opposing surface of said one tooth of the specific user, thereby to rotate the tooth.

20. The method of claim 12, comprising creating additional retainers with differently placed said protrusions for said specific user, said additional retainers designed to be used after said teeth have moved pursuant to use of each previous said retainer.
